(19) United States
(12) Patent Application Publication
(10) Pub. No.: US 2004/0213254 A1
(43) Pub. Date: Oct. 28, 2004

(54) Method for servicing subscribers by utilizing virtual LAN on ATU-R of ADSL

(76) Inventor: Yu-Lin Hwang, Hsinchu (TW)

Correspondence Address: BACON & THOMAS, PLLC, 625 SLATERS LANE, FOURTH FLOOR, ALEXANDRIA, VA, 22314

(21) Appl. No.: 09/893,700

(22) Filed: Jun. 29, 2001

(51) Int. Cl. H04L 12/28

(52) U.S. Cl. 370/395.1; 370/419

(57) ABSTRACT

The invention is a method for servicing subscriber ends by utilizing virtual LAN on ATU-R of ADSL, which utilizes VLAN to generate a plurality of virtual connections in an ADSL connection, couples equipment of each subscriber end to a plurality of subscriber input/output (I/O) ports in ATU-R, adds a switching hub in the ATU-R for identifying tagged data in the virtual connections, connects each subscriber end in the virtual connections with the switching hub via Ethernet, and assigns each subscriber I/O port in the switching hub to one of the virtual connections having a distinct tag. By utilizing this, each virtual circuit may service different subscriber ends, ensure no data packet of each subscriber end assigned to other subscriber line on the same ATU-R.

### FIELD OF THE INVENTION

The present invention relates to services on the Internet and more particularly to a method for servicing subscriber ends by utilizing virtual LAN on ATU-R of ADSL with improved characteristics.

### BACKGROUND OF THE INVENTION

Recently, Internet has known a rapid and a spectacular development, especially the World Wide Web (WWW) portion. In addition to typical e-mail service, it also provides a multimedia service by combining text, pictures, sound, and video. In a sharp contrast to the booming multimedia on Internet, users using conventional dial tone network become more and more unsatisfied with 28.8, 33.6, or 56 kbps transmission rate available from typical modem. Further, users using local area network (LAN) or integrated subscriber digital network (ISDN) become unsatisfied with current transmission rate available from network. It is also understood that multimedia data transmitted on network is large. Hence, Internet service providers (ISPs) propose many high transmission rate solutions for increasing the transmission rate of such multimedia data.

One of the important solutions is digital subscriber line (DSL). Such DSL is different from typical analog-based plain old telephone service (POTS). DSL has many versions which are collectively called xDSL. In the current DSL systems, asymmetrical digital subscriber line (ADSL) is the most important xDSL. ADSL can effect a transmission rate through existing POTS without an expansion of the existing equipment. Specifications related to ADSL have been stipulated. It is envisaged that ADSL based transmission will be widely employed in various fields and our daily life. Advantages brought by ADSL will not only increase speed and efficiency of information transmission but also facilitate work and bring convenience to daily life.

As to the employment of existing telephone line by ADSL system, an ADSL modem is required. This is similar to using modem to access Internet via typical public switch telephone network (PSTN). The data transmission rate of ADSL is 1.5M bps to 9M bps in downloading and that is 64K bps to 640K bps in uploading depending on type of modem, transmission technique, and transmission distance (as the most important factor). Such difference of transmission speeds (i.e., downloading is about ten times faster than uploading) is the reason why it is called asymmetrical. Media employed by ADSL system is twisted pair wire (TPW) which is widely employed by existing telephone line. Hence, conventional dial tone network may become a high speed digital line having high speed data transmission capability without modifying existing transmission line. As such, it is capable of effecting high speed downloading, median speed duplex transmission, and maintaining the connection of existing telephone line without updating equipment in the exchange of central office 10. Referring to FIG. 1, a network structure of typical ADSL system is shown. Two ADSL modems 30, 40 are installed in central office 10 and subscriber end 20 respectively. This completes an ADSL system 1. ADSL modems 30, 40 can effect a high speed data transmission by employing a bandwidth wider than voice technique. Also, an advanced algorithm is employed to divide a transmission line into three channels as follows:

1. Receiving channel: this is an one way (i.e., from exchange to subscriber end) high speed (i.e., transmission rate is 1.536 Mbps to 6.144 Mbps) channel.

2. Transmission channel: this is a duplex (i.e., from exchange to subscriber end and from subscriber end to exchange at the same time) (or one way in some cases) high speed (i.e., transmission rate is 16 Kbps to 640 Kbps) channel.

3. POTS channel: this is a channel having 4 KHz bandwidth for providing POTS service. This is adopted by existing telephone line.

In ADSL system, equipment in central office 10 is coupled to subscriber ends 20 via conventional telephone line. ADSL modem 40 in each subscriber end 20 serves to replace conventional analog telephone. Hence, it is an indispensable equipment in conventional telephone system. In 1 MHz bandwidth of ADSL, the lowest 4 KHz bandwidth (i.e., 0 to 4 KHz) is configured for conventional telephone service. A POTS splitter 41 in modem 40 serves to perform a passive filtering on such bandwidth so as to separate POTS signals from 1 MHz bandwidth. As for 100 KHz to 1.1 MHz bandwidth, at most 6 bps data are transmitted.

In the exchange of central office, ADSL modem 30 modulates (or encodes) data sent from ISP, Internet online signals sent from other central office, or data sent from Intranet into ADSL signals as well as combines 4 KHz POTS signals and ADSL signals. Both ADSL signals and the combined signals are sent to each subscriber end 20 through the existing telephone line. POTS splitter 41 in ADSL modem 40 of each subscriber end 20 may separate POTS signals from digital signals prior to demodulating (or decoding) the same. Such demodulated or decoded signals are sent to equipment of subscriber end 20 (e.g., computer).

Data to be sent from equipment of subscriber end 20 to central office 10 is through ADSL modem 40 of subscriber end 20 wherein digital signals to be uploaded are demodulated or decoded prior to combining with 4 KHz POTS signals. The combined signals are then transmitted to exchange of central office. Then POTS splitter 31 in ADSL modem 30 of exchange of central office 10 may separate POTS signals from digital signals prior to demodulating (or decoding) the same. Such demodulated or decoded uploaded signals are then sent to ISP, Internet subscribers associated with central office, or Intranet.

It is designed that ADSL is an all-weather digital connection and does not cause interference to voice channel. Hence, it is possible of using ADSL to access data and making a call on the same telephone line. As such, it is very popular among consumers. In this regard, many companies involved in telecommunication take advantage of the trend to expand telephone equipment for providing ADSL (i.e., wide band) services. Such services not only increase data transmission efficiency but also bring a great market to the involved companies. Based on a recent research, there are about 70% current conventional telephone subscribers would like to switch to be serviced by network-based telephone in a near future. As such, a potential traffic of telephone line may cause problems to network-based telecommunication service providers due to such significant increase of the number of subscribers and associated demand.

In response, telecommunication service providers may provide service of multiple virtual circuits (VCs) for expansion. However, in data packet processing there is only one counterpart to be serviced in ADSL transmission unit at the customer premises end (ATU-R) 42 of subscriber end 20. Hence, it is a very important thing in ADSL system for each VC in ATU-R 42 servicing different subscribers, ensuring no data packet of each subscriber assigned to other subscriber line on the same ATU-R 42, and ensuring a correctness and safety in data communication of subscribers while expanding the existing equipment by utilizing such low cost mechanism.

### SUMMARY OF THE INVENTION

It is therefore an object of the present invention to provide a method for servicing subscriber ends by utilizing a virtual local area network (VLAN) on an asymmetrical digital subscriber line (ADSL) transmission unit at the customer premises end (ATU-R) of the ADSL. The method comprises utilizing the VLAN to generate a plurality of virtual connections in an ADSL connection; coupling equipment of each subscriber end to a plurality of subscriber input/output (I/O) ports in the ATU-R; adding a switching hub in the ATU-R for identifying tagged data in the virtual connections; connecting each subscriber end in the virtual connections to the switching hub via Ethernet; and assigning each subscriber I/O port in the switching hub to one of the virtual connections having a distinct tag. By utilizing this, each virtual circuit may service different subscriber ends, ensure no data packet of each subscriber end assigned to other subscriber line on the same ATU-R, and there is no need to worry data to be seen by other subscribers during broadcasting the packet.

It is another object of the present invention to provide a method for servicing subscriber ends by utilizing a VLAN on an ATU-R of the ADSL. The method comprises commanding a switching chip to send the data packet to the specified subscriber end based on an identification of the data packet on the virtual connection; commanding the switching chip to perform an identification based on the received data packet for determination; adding a corresponding VLAN tag on the data packet and the identification associated with the virtual connection prior to sending to the CPU; and commanding the CPU to transmit the data packet through the corresponding virtual connection based on the identification of the data packet on the virtual connection. By utilizing this, processing time in the last mile of ADSL system may be reduced, thus increasing the transmission efficiency.

The above and other objects, features and advantages of the present invention will become apparent from the following detailed description taken with the accompanying drawings.

### BRIEF DESCRIPTION OF THE DRAWINGS

FIG. 1 is a network structure of typical ADSL system; and

FIG. 2 is a network structure of an ADSL system according to the invention.

### DETAILED DESCRIPTION OF THE PREFERRED EMBODIMENTS

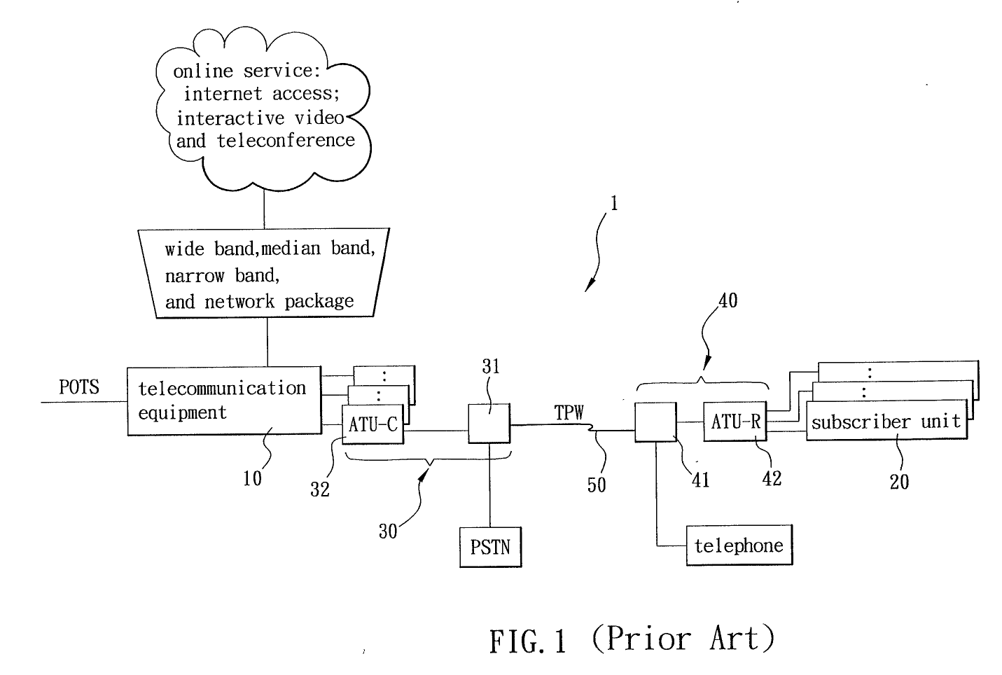

Referring to FIG. 1 again, in the conventional ADSL system 1 there are ATU-R 42 and POTS splitter 41 provided in ADSL modem 40 of subscriber end 20. ATU-R 42 and POTS splitter 41 are coupled to ADSL modem 30 in exchange of central office 10 through TPW 50. ADSL modem 30 consists of ADSL transmission unit at the network end (ATU-C) 32 and POTS splitter 31. With this configuration, ADSL modem 40 and ADSL modem 30 can transmit and receive voice data and network packets therebetween.

In general, there is only one LAN port in most ATU-Rs. However, it is impossible of neither servicing multiple subscribers nor distinguishing different subscribers if there are provided many input/output (I/O) ports which are located on the same broadcast domain. Basically, an independent ADSL modem 40 is required to install in subscriber end 20 so that ADSL system may provide desired wide band network service. Further, ATR-U 42 is required to employ a portion of the connection (or called last mile) to connect to ADSL modem 30 in exchange of central office 10. In a few complicated ATU-Rs, there are more than one independent I/O port provided and a routing technique is utilized for servicing multiple subscribers by a single ADSL connection. However, it may increase cost. To the worse, it does not support the current most popular bridging technique, resulting in a less flexibility to central office and subscribers.

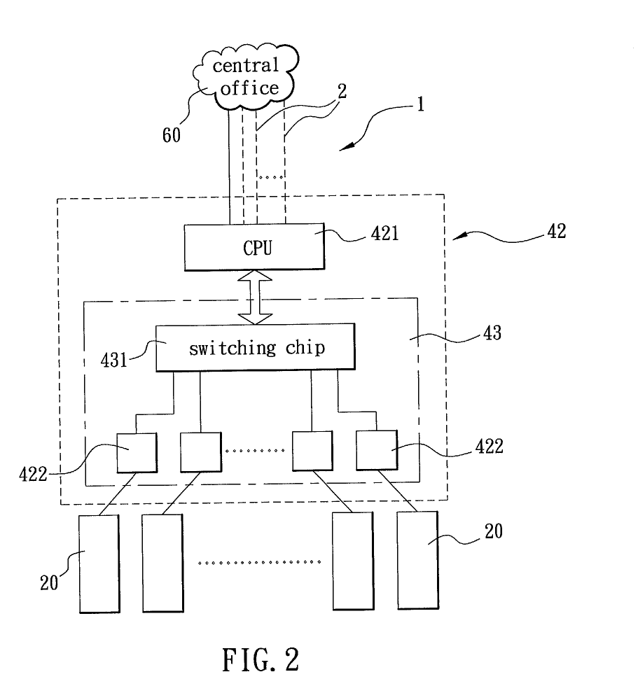

Referring to FIG. 2, there is shown a network structure of an ADSL system constructed in accordance with the invention. The invention utilizes a virtual LAN (VLAN) technique to generate a plurality of virtual connections 2 in ADSL connection 1. Further, equipment of each subscriber end coupled to subscriber I/O ports 422 in ATU-R 42 may communicate with central office 60 (or ISP) through ADSL connection 1 and virtual connections 2. The characteristic of VLAN technique is to encode data sent from each subscriber end 20 coupled to subscriber I/O ports 422 in ATU-R 42 so as to add a tag to data. As a result, a plurality of virtual connections are generated as a service expansion. However, in data packet processing there is only one counterpart to be serviced in ATU-R 42. Hence, the invention adds a switching hub 43 in ATU-R 42. As a result, programs installed in switching hub 43 can identify tagged data in virtual connections 2. Further, each subscriber end 20 in virtual connections 2 can connect to switching hub 43 via Ethernet. Hence, each subscriber I/O port 422 in switching hub 43 is assigned to a virtual connection 2 having a distinct tag.

Furthermore, each virtual connection 2 can service different subscribers 20 so as to ensure no data packet of each subscriber assigned to other subscriber line on the same ATU-R. As a result, in the last mile of ADSL system the transmission efficiency is increased significantly, services provided by central office is more satisfactory, and the operating cost is reduced.

In the invention, there is provided a switching chip 431 in switching hub 43 for performing packet switching. As data packet sent from central office 60 (or ISP) to ATU-R 42 in subscriber end through ADSL connection 1, central processing unit (CPU) 421 of ATU-R 42 may identify the received data packet for determining which subscriber end that an identification (i.e., VPI/VCI) of data packet on virtual connection 2 belongs to. Further, add a corresponding VLAN tag on the data packet based on the information. The VPI/VIC is included in the virtual connection 2 belonging to subscriber end 20. As data packet sent to switching chip 431, switching chip 431 may send the data packet to specified subscriber end 20 based on ID of data packet in virtual connection 2.

In the invention, if a subscriber end 20 has sent data packet to central office 60 (or ISP) through ADSL connection 1, switching chip 43 in ATU-R 42 may perform an identification based on the received data packet for determining which virtual connection 2 that subscriber I/O port 422 belongs to. Further, a corresponding VLAN tag is added on the data packet and an ID associated with the virtual connection prior to sending to CPU 421 in ATU-R 42. CPU 421 then transmits the data packet through corresponding virtual connection 2 based on ID of the data packet on virtual connection 2. By utilizing the invention, each subscriber end 20 in ATU-R 42 may possess independent virtual connection 2. Further, there is no need to worry data to be seen by other subscribers during broadcasting the packet.

While the invention has been described by means of specific embodiments, numerous modifications and variations could be made thereto by those skilled in the art without departing from the scope and spirit of the invention set forth in the claims.

What is claimed is:

1. A method for servicing subscriber ends by utilizing a virtual local area network (VLAN) on an asymmetrical digital subscriber line (ADSL) transmission unit at the customer premises end (ATU-R) of said ADSL, said method comprising:
utilizing said VLAN to generate a plurality of virtual connections in an ADSL connection;
coupling equipment of each subscriber end to a plurality of subscriber input/output (I/O) ports in said ATU-R;
adding a switching hub in said ATU-R for identifying tagged data in said virtual connections;
connecting each subscriber end in said virtual connections to said switching hub via Ethernet; and
assigning each subscriber I/O port in said switching hub to one of said virtual connections having a distinct tag.

2. The method of claim 1, further comprising:
providing a switching chip in said switching hub for performing a packet switching;
as a data packet sent from a central office to said ATU-R in said subscriber end through said ADSL connection, commanding a central processing unit (CPU) of said ATU-R to identify said received data packet for determining which one of said subscriber ends that an identification of said data packet on said virtual connection belongs to;
adding a corresponding VLAN tag on said data packet based on determination wherein said identification is included in said virtual connection belonging to said subscriber end; and
as said data packet sent to said switching chip, commanding said switching chip to send said data packet to said specified subscriber end based on said identification of said data packet on said virtual connection.

3. The method of claim 1, further comprising:
as one of said subscriber ends has sent said data packet to said central office through said ADSL connection, commanding said switching chip to perform an identification based on said received data packet for determining which one of said virtual connections that said subscriber I/O port belongs to;
adding said corresponding VLAN tag on said data packet and said identification associated with said virtual connection prior to sending to said CPU; and
commanding said CPU to transmit said data packet through said corresponding virtual connection based on said identification of said data packet on said virtual connection.
